(19) United States
(12) Patent Application Publication
(10) Pub. No.: US 2010/0170917 A1
(43) Pub. Date: Jul. 8, 2010

(54) PUMPING TYPE COSMETIC CONTAINER

(75) Inventor: Joong-Hyun Ki, Incheon (KR)

Correspondence Address: CANTOR COLBURN, LLP, 20 Church Street, 22nd Floor, Hartford, CT, 06103, US

(73) Assignee: YONWOO CO., LTD., Incheon (KR)

(21) Appl. No.: 12/668,172

(22) PCT Filed: Nov. 21, 2008
(86) PCT No.: PCT/KR08/06895

§ 371 Date: Jan. 7, 2010

(30) Foreign Application Priority Data
Mar. 25, 2008 (KR) 20-2008-0003873

(51) Int. Cl. G01F 11/00

(52) U.S. Cl. 222/256; 222/321.9

(57) ABSTRACT

The invention relates to a pumping type cosmetic container. The pumping type cosmetic container according to the invention includes a storage container in which contents are stored; a fastener that is fitted to an upper portion of the storage container and includes an insertion hole formed at the center of the fastener so as to pass through the fastener; a piston rod that is fitted to the insertion hole; a dispenser that is fitted to a lower portion of the piston rod, has a diameter smaller than the diameter of the insertion hole, and includes a check valve, into which the contents flow due to pressure; and a cap that is fitted to an upper portion of the piston rod and includes an outlet through which the contents are discharged. A scraper is provided at a lower portion of the storage container, and a stopper of which the diameter is equal to or larger than the diameter of the insertion hole is formed at an upper portion of the piston rod.

### TECHNICAL FIELD

The present invention relates to a pumping type cosmetic container, and more particularly, to a pumping type cosmetic container that discharges a predetermined amount of contents through an outlet formed at an upper portion of a button when the button is pressed, so as to allow a user to directly apply the contents to the skin.

### BACKGROUND ART

In general, various kinds of contents (skin lotion, lotion, eye cream, or the like) are received in a cosmetic container. When consuming the contents, a user upsets the cosmetic container so as to discharge the contents.

However, there is the following problem. That is, if the user discharges and consumes the contents as described above, it is difficult for the user to discharge a predetermined amount of the contents (skin lotion, lotion, eye cream, or the like) and to difficult for the user to discharge and consume the contents when a small amount of contents remains in the storage container.

Further, various kind of pumping type cosmetic containers have been proposed in order to overcome this problem. However, there is a problem in that the discharged contents remain and are hardened at the end of a nozzle so as to clog an opening of the nozzle.

### DISCLOSURE OF INVENTION

### Technical Problem

The present invention has been made to solve the above-mentioned problems, and an object of the present invention is to provide a pumping type cosmetic container that discharges a predetermined amount of contents through an outlet formed at an upper portion of a button when the button is pressed, so as to allow a user to directly apply the contents to the skin.

Further, another object of the present invention is to provide a pumping type cosmetic container where contents do not flow through an outlet and are not hardened since contents do not remain at an end of an outlet.

### Technical Solution

In order to solve the above-mentioned problems, the pumping type cosmetic container according to the invention includes a storage container in which contents are stored; a fastener that is fitted to an upper portion of the storage container and includes an insertion hole formed at the center of the fastener so as to pass through the fastener; a piston rod that is fitted to the insertion hole; a dispenser that is fitted to a lower portion of the piston rod, has a diameter smaller than the diameter of the insertion hole, and includes a check valve, into which the contents flow due to pressure; and a cap that is fitted to an upper portion of the piston rod and includes an outlet through which the contents are discharged. A scraper is provided at a lower portion of the storage container, and a stopper of which the diameter is equal to or larger than the diameter of the insertion hole is formed at an upper portion of the piston rod.

Further, the outlet may be formed so that the contents are discharged in a horizontal direction.

Furthermore, the piston rod and the dispenser may be spaced apart from each other by a predetermined distance in a vertical direction, and the discharged contents may be sucked again.

Further, the pumping type cosmetic container may further include a spring that is provided between the fastener and the stopper.

### Advantageous Effects

As described above, according to the invention, it may be possible to obtain an advantage of discharging a predetermined amount of contents through an outlet formed at an upper portion of a button by pressing the button so that the contents are directly applied to the skin.

Further, it may be possible to obtain an advantage where contents do not flow through an outlet and are not hardened since contents do not remain at an end of an outlet.

### BRIEF DESCRIPTION OF DRAWINGS

The above and other features and advantages of the present invention will become more apparent by describing in detail exemplary embodiments thereof with reference to the attached drawings in which:

FIG. 1 is a front view of a pumping type cosmetic container according to a preferred embodiment of the invention;

FIG. 2 is a side cross-sectional view of the pumping type cosmetic container according to the preferred embodiment of the invention;

FIG. 3 is a partially enlarged view of the pumping type cosmetic container according to the preferred embodiment of the invention;

FIG. 4 is a view illustrating the use state of pumping type cosmetic container according to the preferred embodiment of the invention;

FIG. 5 is a view showing that a button of the pumping type cosmetic container according to the preferred embodiment of the invention is pressed;

FIG. 6 is a view showing that the button of the pumping type cosmetic container according to the preferred embodiment of the invention is released; and

FIG. 7 is a view showing that the surplus amount of contents is sucked into the pumping type cosmetic container according to the preferred embodiment of the invention again.

### BEST MODE FOR CARRYING OUT THE INVENTION

The invention will be described in detail below with reference to drawings. The same reference numeral shown in each drawing denotes the same element.

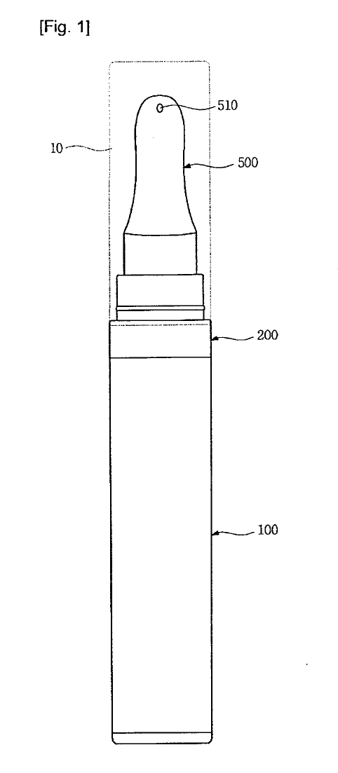

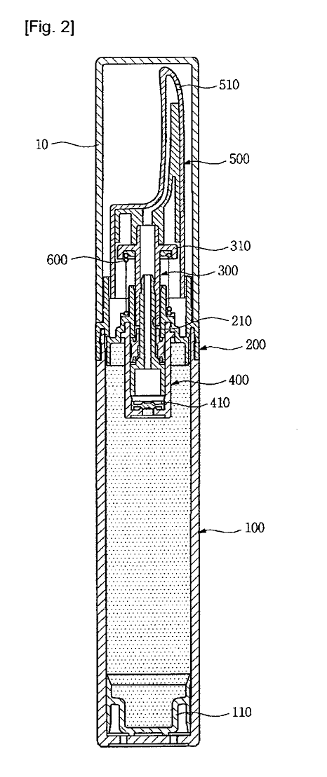

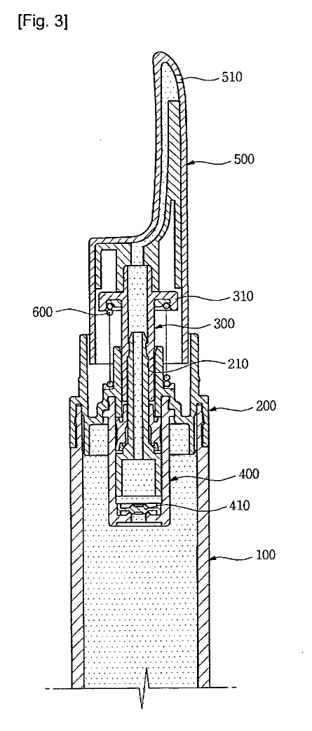

FIG. 1 is a front view of a pumping type cosmetic container according to a preferred embodiment of the invention, FIG. 2 is a side cross-sectional view of the pumping type cosmetic container according to the preferred embodiment of the invention, and FIG. 3 is a partially enlarged view of the pumping type cosmetic container according to the preferred embodiment of the invention. As shown in FIGS. 1 to 3, the pumping type cosmetic container according to the preferred embodiment of the invention includes a storage container 100, a fastener 200, a piston rod 300, a dispenser 400, and a cap 500, and may further include a spring 600.

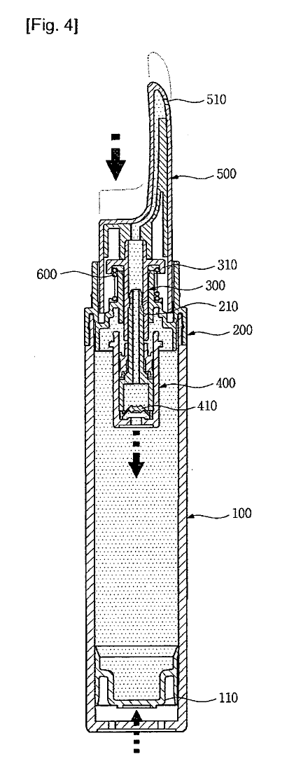

The storage container 100 receives contents (skin lotion, lotion, or eye cream). Referring to FIG. 4, a scraper 110 is provided at the lower portion of the storage container 100. As a user consumes a predetermined amount of contents, the storage container is compressed, so that the scraper 110 is moved toward the upper portion of the storage container 100. Accordingly, even though the amount of contents remaining in the storage container 100 is small, a user consumes the contents without inconvenience.

The fastener 200 is fitted to the upper portion of the storage container 100, and an insertion hole 210 is formed at the center of the fastener so as to pass through the fastener. Further, when not consuming the contents, a user may keep the fastener 200 while a lid 10 is fit to the fastener. The fastener 200 seals the storage container 100 in which the contents are stored, and a piston rod 300 to be described below is fitted to the insertion hole 210.

A piston rod 300 is fitted to the insertion hole 210, and the diameter of the piston rod 300 is equal to the diameter of the insertion hole 210 so that the contents stored in the storage container 100 are not discharged to the outside. A stopper 310, of which the diameter is equal to or larger than the diameter of the insertion hole 210, is formed at the upper portion of the piston rod 300. The stopper 310 prevents the piston rod 300 from being separated from the fastener into the storage container 100 after the piston rod passes through the insertion hole 210. Further, a cap 500 to be described below is fitted to the upper portion of the piston rod 300. When a user presses the cap 500, the piston rod 300 is pressed down.

Meanwhile, the spring 600 may be provided between the stopper 210 and the piston rod 300. After the piston rod 300 is pressed down and moved downward, the piston rod 300 is moved upward again by the restoring force of the spring 600.

The dispenser 400 is formed to have a diameter that is equal to or larger than the diameter of the insertion hole 210, and is fitted to the lower portion of the piston rod 300. Accordingly, the dispenser 400 prevents the piston rod 300 from being separated from the insertion hole 210 toward the upper side. Further, a check valve 410 is provided at the lower portion of the dispenser 400. Accordingly, if pressure is applied to the check valve 410, the contents flow into the dispenser 400. The contents, which have flowed as described above, are discharged to the outside through an outlet 510, which is described below, via the piston rod 300.

The cap 500 is fitted to the upper portion of the piston rod 300, and the inside of the cap communicates with the piston rod 300. The outlet 510 through which the contents are discharged is formed at the cap 500. If a user presses the cap 500, the dispenser 400 fitted to the lower portion of the piston rod 300 is moved downward together with the piston rod 300 as described above. Further, the inside of the storage container 100, which is filled with the contents, is pressed by the check valve 410 as much as the volume where the dispenser 400 is moved downward. As a result, cosmetics are discharged through the outlet 510 via the piston rod 300.

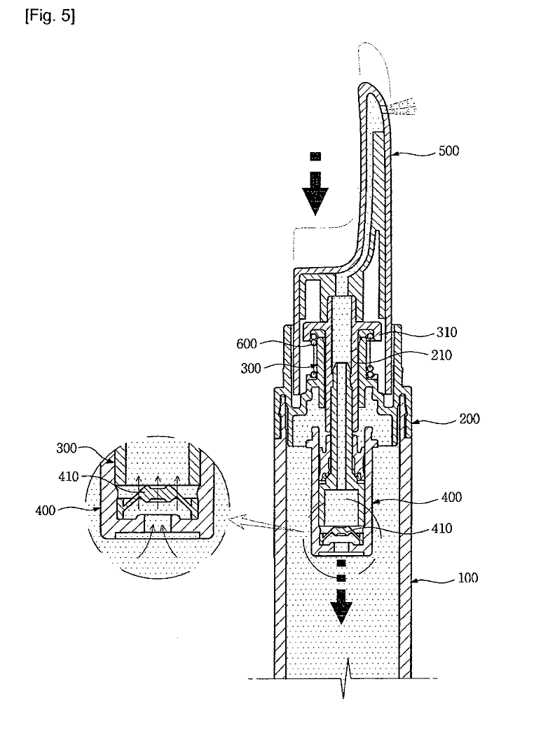

The use state of the pumping type cosmetic container according to the preferred embodiment of the invention will be described below with reference to FIGS. 5 to 7.

Referring to FIG. 5, if a user presses a button 500, the piston rod 300 and the dispenser 400 are moved downward by the button 500. In this case, since the contents presses the check valve 410 as much as the volume where the dispenser 400 is moved downward, the contents flow into the dispenser 400 and are discharged to the outside through the outlet 510. When the button 500 is pressed, the contents are discharged to the outside. Accordingly, the pumping type cosmetic container is suitable for a storage container of eye cream that is to be applied to the skin below the eyes.

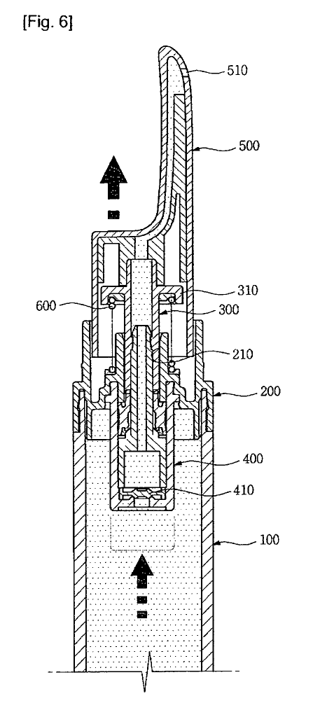

After that, referring to FIG. 6, the piston rod 300 is moved upward by the restoring force of the spring 600. Further, since the storage container 100 is sealed, the scraper 110 is moved upward as much as the volume where the dispenser 400 is moved downward. Accordingly, the storage container 100 is always sealed, and a user can consume the contents as long as the contents remain in the storage container.

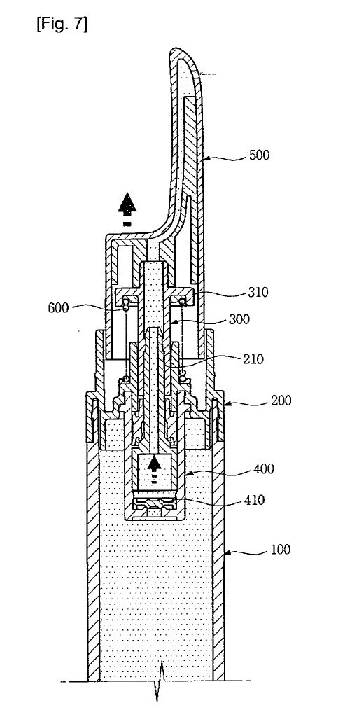

After that, referring to FIG. 7, the piston rod 300 and the dispenser 400 are spaced apart from each other by a predetermined distance in a vertical direction. Even after the upward movement of the dispenser 400 is stopped by the fastener 200, the piston rod 300 is further moved upward as much as a distance between the piston rod and the dispenser 400. Accordingly, according to the invention, since the inside of the dispenser 400 is blocked by the check valve 410, the contents remaining in the button 500 are sucked as much as the distance between the piston rod 300 and the dispenser 400 again.

Preferred embodiments have been disclosed in the drawing and specification. Specific terms have been used herein. However, the specific terms have been used to describe the invention, and do not limit meanings or the scope and sprit of the invention that are disclosed in the claims. Accordingly, those skilled in the art can understand that various modifications and other equivalent embodiments may be made from the scope of the invention. Therefore, the scope of the invention should be defined by the appended claims.

1. A pumping type cosmetic container comprising:
a storage container 100 in which contents are stored, a scraper 110 being provided at a lower portion of the storage container;
a fastener 200 that is fitted to an upper portion of the storage container 100, an insertion hole 210 being formed at the center of the fastener so as to pass through the fastener;
a piston rod 300 that is fitted to the insertion hole 210, a stopper 310 of which the diameter is equal to or larger than the diameter of the insertion hole 210 being formed at an upper portion of the piston rod;
a dispenser 400 that is fitted to a lower portion of the piston rod 300, has a diameter smaller than the diameter of the insertion hole 210, and includes a check valve 410, into which the contents flow due to pressure; and
a cap 500 that is fitted to an upper portion of the piston rod 300 and includes an outlet 510 through which the contents are discharged.

2. The pumping type cosmetic container according to claim 1,
wherein the outlet 510 is formed so that the contents are discharged in a horizontal direction.

3. The pumping type cosmetic container according to claim 1,
wherein the piston rod 300 and the dispenser 400 are spaced apart from each other by a predetermined distance in a vertical direction, and the discharged contents are sucked again.

4. The pumping type cosmetic container according to claim 1, further comprising:
a spring 600 that is provided between the fastener 200 and the stopper 310.
